(19) United States
(12) Patent Application Publication
(10) Pub. No.: US 2004/0212595 A1
(43) Pub. Date: Oct. 28, 2004

(54) Software keyboard for computer devices

(76) Inventor: Debiao Zhou, Tokyo (JP)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/424,607

(22) Filed: Apr. 28, 2003

(51) Int. Cl. G09G 5/00

(52) U.S. Cl. 345/168

(57) ABSTRACT

A system and techniques are disclosed to provide a movable, resizable, and configurable software keyboard for computer devices. The system provides an application-programming interface for other applications to systematically customize and display one or more software keyboards in a particular context.

### TECHNICAL FIELD

This invention relates to a software keyboard for computer devices.

### BACKGROUND

Personal computer systems have increasingly been accepted by a number of users. With the ever-increasing development of small computer devices (e.g., personal digital assistants (‘PDAs’), personal organizers, and mobile devices), users are demanding efficient and optimal ways to enter data. Traditionally, keyboards on small computer devices are fixed and are located at the bottom of display screens. This keyboard location, however, has resulted in application input fields being obscured from user view. In some systems, a scroll bar is provided to allow a user to display obscured application input fields. The use of such a scroll bar on small computer devices, however, can be both time-consuming and cumbersome for users.

### SUMMARY

A system and related techniques are disclosed to provide a movable, resizable, and configurable software keyboard for computer devices. The system provides an application-programming interface (“API”) for other applications to systematically customize and display one or more software keyboards in a particular context.

For example, according to one aspect, a method includes providing a keyboard customization application to configure a user-customized configuration file and generating a user-customized software keyboard on a display in response to a request using the user-customized configuration file as input.

In some implementations, the method also may include providing one or more key palettes comprising one or more keys for selection in the user-customized software keyboard and providing the keyboard customization application with a key customization area for modifying individual key font type, key font size, and key font shape for selection in the user-customized software keyboard. The keyboard customization application may be provided with a key formula area for specifying one or more instructions to be associated with a user-defined key, and may be provided with a keyboard layout area for arranging a position of one or more individual keys in the user-customized keyboard.

In another aspect, a method includes providing an application programming interface to configure an application-customized software keyboard on a display and generating an application-customized software keyboard from a request using an application programming interface as input.

In some implementations, the method also may include providing the application programming interface with one or more functions to request a keyboard adaptation process to generate the application-customized software keyboard in a computer memory.

According to another aspect, a method includes receiving an instruction from a requester to display the application-customized software keyboard and a set of keyboard parameters comprising a memory address pointer and keyboard display coordinate values. The application-customized software keyboard is displayed using as input the memory address pointer, the keyboard display coordinate values, and a computer graphics library.

A system, as well as articles that include a machine-readable medium storing machine-readable instructions for implementing the various techniques, is disclosed. Details of various implementations are discussed in greater detail below.

In some implementations, one or more of the following advantages may be present. For example, the software keyboard may be movable and resizable on the display screen of the small computer device. This may be particularly advantageous for users and application developers because display screen size may be limited. Users may no longer need to use scroll bars to view obscured application input fields, and application developers also may benefit by utilizing a larger area of the display screen to display relevant application information.

Another benefit of the system may relate to the capturing and prompting of frequently entered words. For example, as a user is entering data on the keyboard, the system may prompt the user with words that have been entered previously. A user may select one of these prompted words and reduce data entry time and the number of potential data entry errors.

The system further provides an application programming interface that may benefit application developers and users. The API provides application developers with a technique to direct the position and appearance of the keyboard from an application. Applications may control when to show or hide a particular keyboard and where on the display screen the keyboard should appear. Users may benefit from the API in that only an appropriate keyboard may be displayed in a particular context to reduce user distraction and potential data entry errors. For example, an application may automatically display a numeric-only keyboard when a user selects to enter data into a numeric field and an alpha-only keyboard when a user selects to enter data into an alphabetic field.

Additional features and advantages will be readily apparent from the following detailed description, the accompanying drawings and the claims.

### BRIEF DESCRIPTION OF THE DRAWINGS

FIG. 1 illustrates a network configuration for small computer devices.

FIG. 2 illustrates an example of a small computer device.

FIG. 3 illustrates a key customization application for creation of a customized keyboard.

FIG. 4 illustrates a keyboard configuration display.

FIG. 5 illustrates creation of a user-defined keyboard.

FIG. 6 illustrates a save option used in a keyboard customization application.

FIG. 7 illustrates a method of generating a keyboard configuration file.

FIG. 8 illustrates opening a keyboard configuration file in a keyboard customization application.

FIG. 9 illustrates modifications that may be made to an existing keyboard configuration.

FIG. 10 illustrates a keyboard synchronization process.

FIG. 11 illustrates a method for rendering a user-defined keyboard.

FIG. 12 illustrates use of an application programming interface on a small computer device.

### DETAILED DESCRIPTION

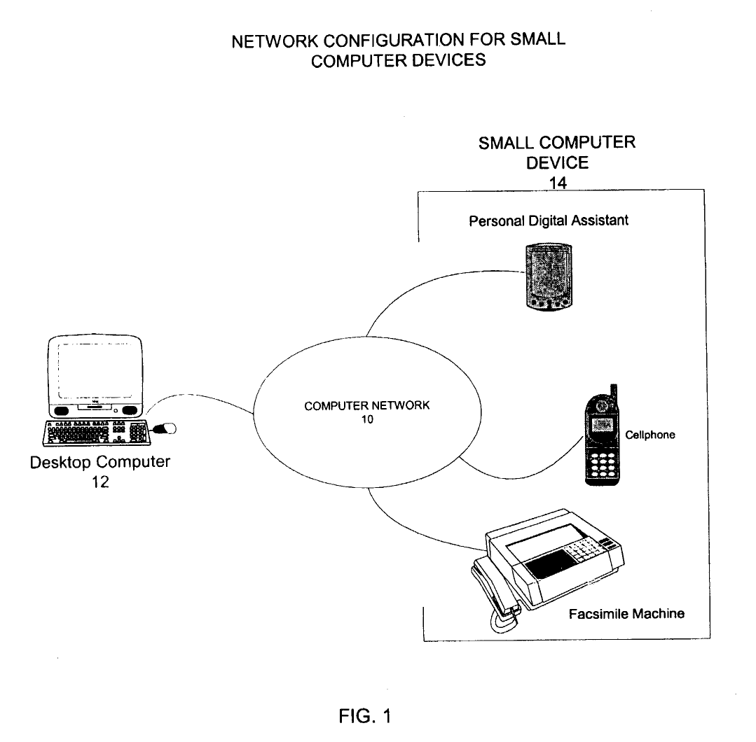

As illustrated in FIG. 1, a system is configured with a desktop computer 12, a small computer device 14 (e.g., a personal digital assistant (‘PDA’), a mobile cell phone, a facsimile machine), and a computer network 10.

The computer network 10 may transmit information electronically between desktop computer 12 and small computer device 14. Various types of network topologies and data communication facilities may be supported by computer network 10. In one embodiment, for example, computer network 10 may be land-line based (e.g., gigabit and fast Ethernets, FDDI networks, ISDN and 100VG-Anylan). In another embodiment, wireless-based technologies (e.g., cellular mobile radio, wireless access protocol (WAP), Bluetooth, and infrared) may be used for data communication between desktop computer 12 and small computer device 14. Other embodiments may transmit information through a serial connection or a universal serial bus (‘USB’) connection between small computer device 14 and desktop computer 12.

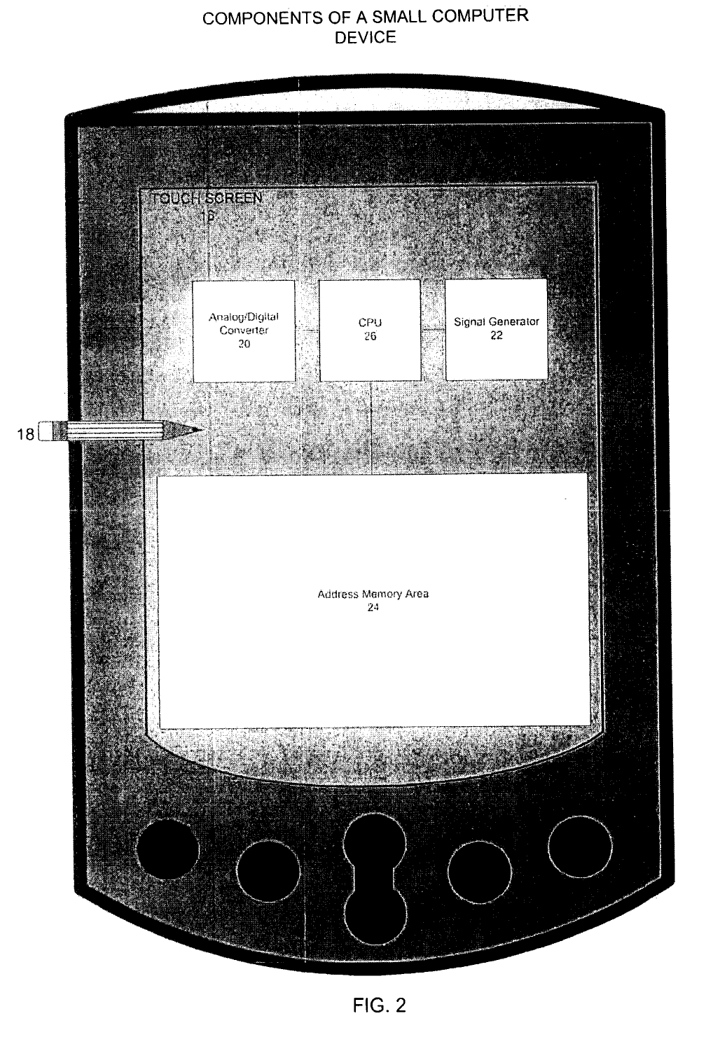

Referring to FIG. 2, small computer device 14 includes a touch screen 16, a stylus 18 for data entry on touch screen 16, an analog/digital converter 20, a signal generator 22, an address memory area 24 and a central processing unit (‘CPU’) 26.

Touch screen 16 may be used for displaying a software keyboard and other information (e.g., images, spread-sheets, electronic mail) according to control of CPU 26. In addition to displaying information, touch screen 16 also may be used as an input device. If a location on touch screen 16 is selected using stylus 18, an analog coordinate value may be generated representing the position of contact with touch screen 16.

The analog/digital converter 20 converts an analog coordinate value to a digital coordinate value by selecting a location on touch screen 16.

Memory address area 24 is provided to store one or more keyboard configuration files, executable keyboard software code, and keyboard application programming interface libraries for displaying a software keyboard on touch screen 16. Memory address area 24 also may store keyboard customization applications that may be used to generate and modify one or more software keyboard configurations stored in memory address area 24.

Signal generator 22 synchronizes CPU 26 with memory address area 24, analog/digital converter 20 and touch screen 16.

CPU 26 displays a keyboard image on touch screen 16, directs analog/digital converter 20 to provide a digital coordinate corresponding to a selected area on touch screen 16, and determines keyboard key selection using the digital coordinate generated by analog/digital converter 20 as input.

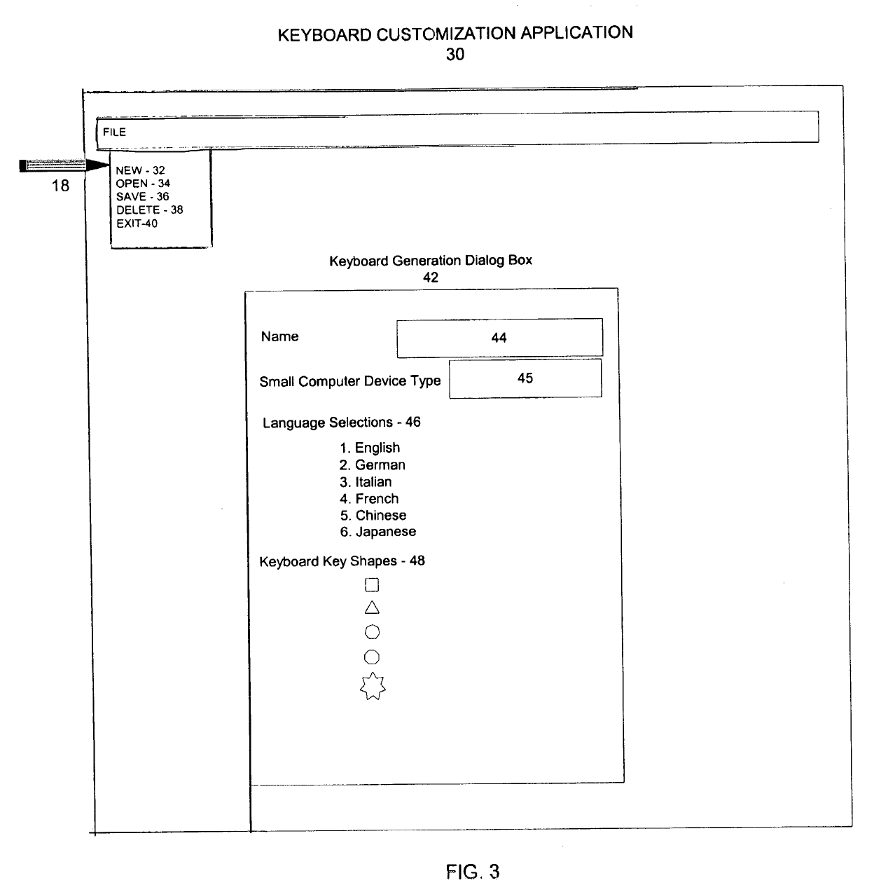

As shown by FIG. 3, the system provides a keyboard customization application 30, which may be used to generate and modify software keyboards containing user-selected preferences. In one embodiment, for example, keyboard customization application 30 may be deployed on a Java 2 Platform, Micro Edition (‘J2ME™’) environment and operate on small computer device 14. In other embodiments, keyboard customization application 30 may be deployed in other graphical computer environments and operate on desktop computer 12 and small computer device 14.

Keyboard customization application 30 includes several file menu options that may be used to generate and customize software keyboard. Referring to FIG. 3, for example, the following menu options may be provided: a new option 32, an open option 34, a save option 36, a delete option 38 and an exit option 40.

New option 32 allows a user to generate a new software keyboard. In one implementation, for example, selecting new option 32 with stylus 18 automatically displays a keyboard generation dialog box 42 that provides a name field 44 for associating a name with a software keyboard, one or more available language selections 46 for software keyboard keys, and a set of keyboard shapes 48 that may be selected for keyboard keys. As illustrated in FIG. 3, both single-byte languages (e.g., English, German, Italian and French) as well as multi-byte languages (e.g., Chinese and Japanese) may be supported by the system.

Each keyboard key may have associated with it one or more name-value pairs representing attributes entered and selected from keyboard generation dialog box. In one embodiment, for example, a unique identifier and the following name-value pair attributes may be stored for each key: name::name_field, language::language_selected, keyshape::selectedShape, keyfont::_keyfont, and keysize::_keysize. Other implementations may store additional or different information for each key to be configured in the software keyboard.

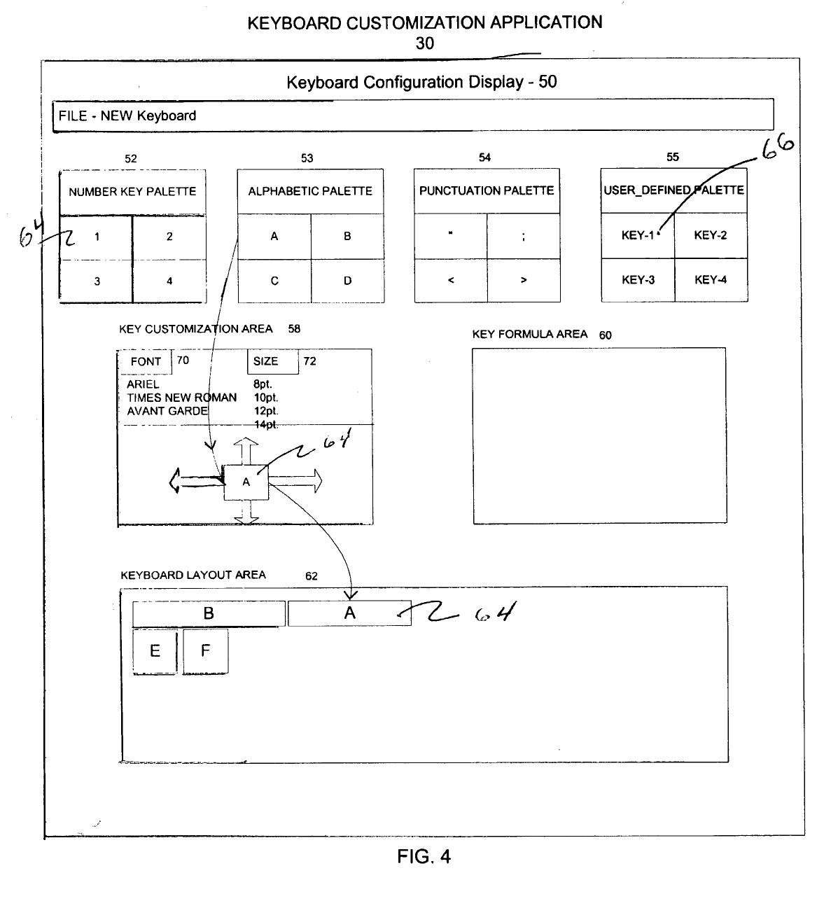

Referring to FIG. 4, a keyboard configuration display 50 may be displayed once selections from keyboard generation dialog box 42 are performed. Keyboard configuration display 50 allows for the construction of keyboard layouts according to individual preferences. In one embodiment, for example, keyboard configuration display 50 includes a number key palette 52, an alphabet key palette 53, a punctuation palette 54, a user-defined key palette 55, a key customization area 58, a key formula area 60 and a keyboard layout area 62.

Number key palette 52 provides numeric keys that may be included in a keyboard. Referring to FIG. 4, for example, a user may select KEY-A 64 from number palette 52 and copy and paste KEY-A 64 into key customization area 58.

Alphabetic key palette 53 and punctuation key palette 54 provide a set of alphabetic and punctuation keys that may be included in a keyboard. Alphabetic key palette 53 and punctuation key palette 54 represent valid lexicons associated with a selected language selection that may be copied and pasted to key customization area 58. Other embodiments may provide for the movement of selected keys from palettes to key customization area 58 by using drag-and-drop functionality.

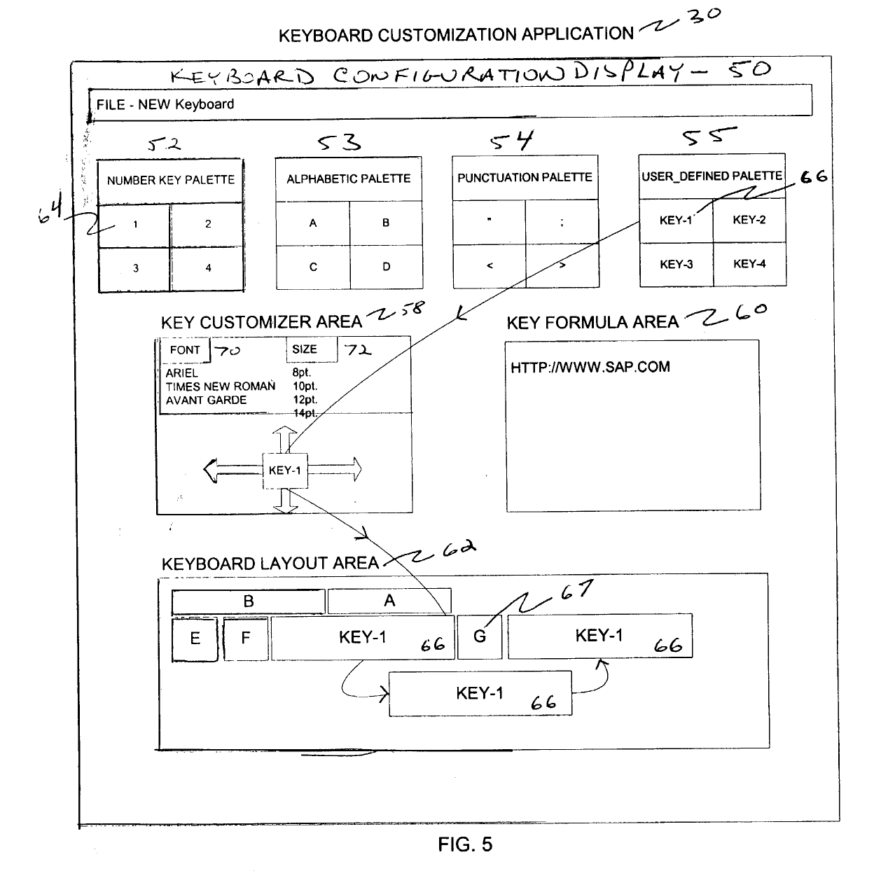

User-defined key palette 55 allows for the establishment of one or more keyboard keys to execute a specific task. In one embodiment, a user may select a user-defined key and copy and paste the user-defined key into key customization area 58 (i.c. see FIG. 5). Once the user-defined key has been copied to key customization area 58, key formula area 60 may be activated to allow one or more commands to be associated with the user-defined key. As illustrated in FIG. 5, for example, the website www.sap.com may be entered into key formula area 60 and may be associated with KEY-1 66. Once the software keyboard is generated, selecting KEY-1 66 may automatically launch a web browser on small computer device 14 and display the www.sap.com website on touch screen 16.

Referring to FIG. 4, key customization area 58 further provides functionality for the individual customization of keyboard keys. Once a key is selected from a palette and copied to key customization area 58, font selector 70 and font size 72 may be provided to adjust key font type and size respectively. Furthermore, key customization area 58 is a design space wherein the width and height of keys selected from palettes may be enlarged or diminished. In one embodiment, for example, selecting a side of KEY-A 64 in key customization area 58 and dragging selected side of key KEY-A 64 in either a vertical or horizontal direction, may reshape KEY-A 64 to a desired shape. Once KEY-A 64 key font type, size and shape are configured according to preference, KEY-A 64 may be moved to keyboard layout area 62 using drag-and-drop functionality.

Keyboard layout area 62 receives configured palette keys as input from key customization area 58. Keyboard layout area 62 is a drawing area that establishes geometry among configured palette keys. Keyboard layout area 62 may be used to arrange configured key sequences for the software keyboard. Referring to FIG. 5, for example, a user may select KEY-1 66 from key customization area 58 and drag it to the right side of alphabet key 67. Once KEY-1 66 is positioned to the right of alphabet key 67, keyboard layout area 62 will maintain this geometric information in a configuration file for the particular software keyboard.

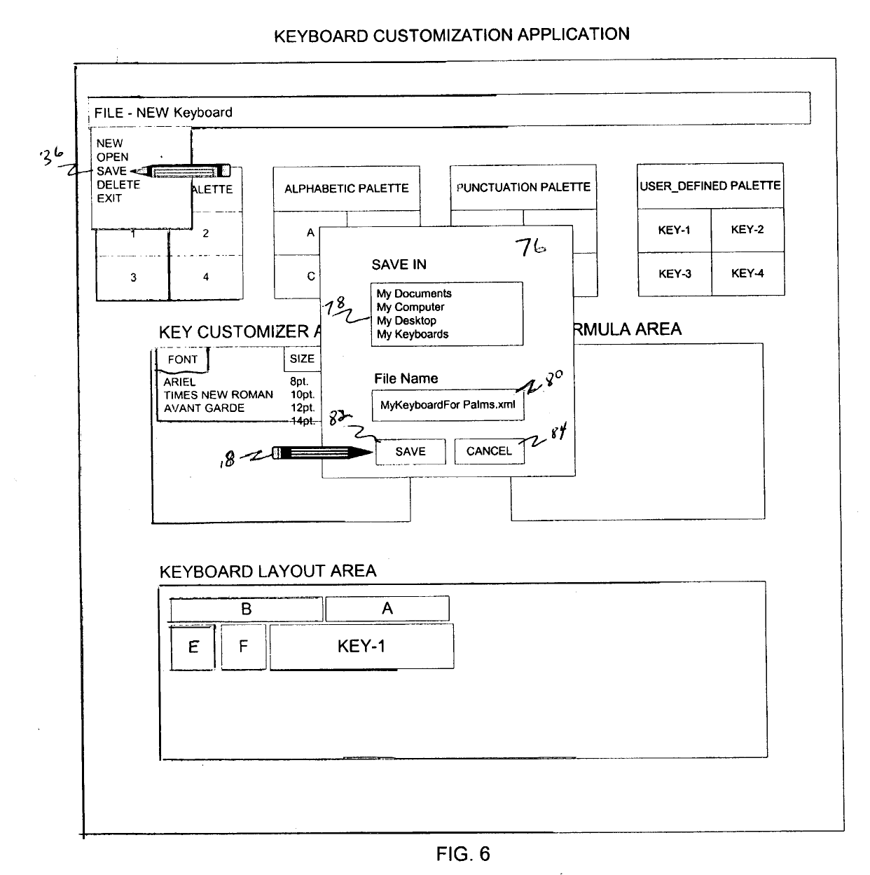

Save menu option 36 may be provided to save keyboard configurations established in keyboard layout area 62. Referring to FIG. 6, for example, selecting save menu option 36 displays a save dialog box 76 that includes a directory list 78, a file name field 80, a save button 82 and a cancel button 84. Directory list 78 displays a computer file system structure that may be used for storing keyboard configuration files. File name field 80 allows a user to specify a name for a keyboard configuration file. Save button 82 may be used to execute a keyboard property script that generates keyboard configuration files. Cancel button 84 is provided to close save dialog box 76.

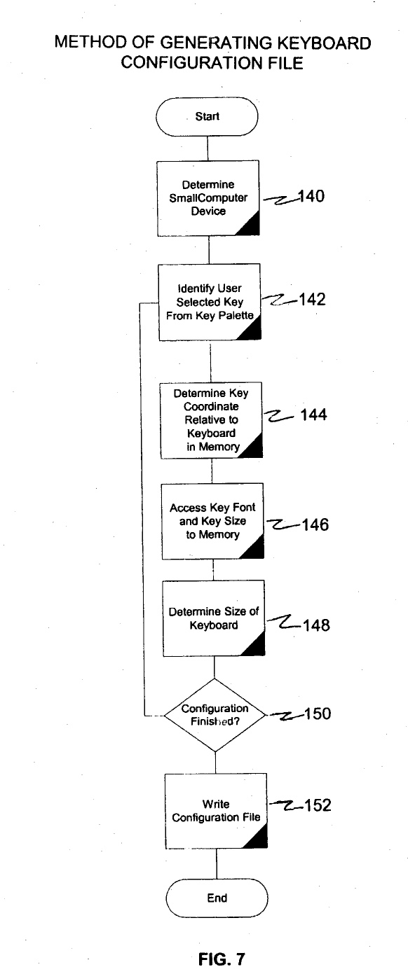

FIG. 7 illustrates a method of generating a keyboard configuration file. A keyboard property script 86 initially determines the type of computer device the keyboard may be used on 140. This information may be obtained from small computer device type 45 specified in keyboard generation dialog box 42. Keyboard property script 86 then identifies a user-selected key from the one or more key palettes 142. Once a key is selected from the one or more key palettes, keyboard property script 86 calculates horizontal and vertical coordinate values for the user-selected key relative to the overall number of keys to be included in the software keyboard 144. In addition, key font type and size may be determined 146 by accessing key attributes established in key customization area 58. Next, keyboard property script 86 determines the size of the overall software keyboard 148 by summing the horizontal and vertical coordinate values calculated for a key. Once properties for all of the keys configured in keyboard layout area 62 are processed 150, a configuration file may be written 152 to a computer file system structure.

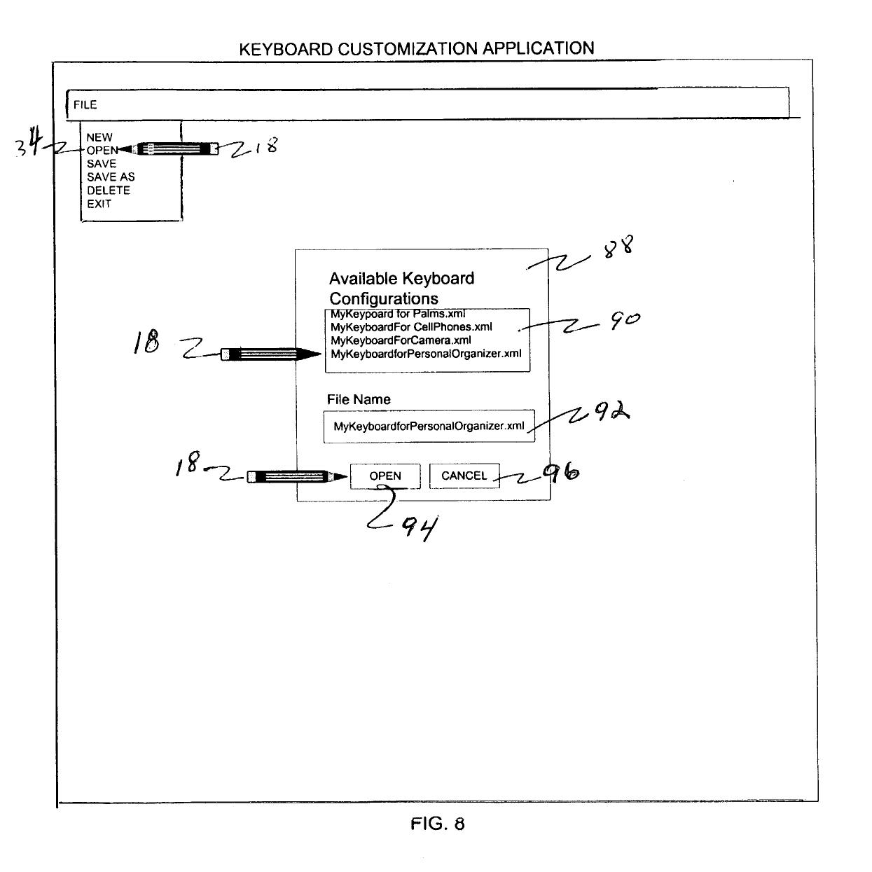

Referring to FIG. 8, open menu option 34 is provided to access an already existing set of configuration files for one or more software keyboards. Upon selecting open menu option 34, the system automatically displays an available keyboard dialog box 88 including a list of available keyboards 90, an open file name field 92, an open button 94 and a cancel button 96.

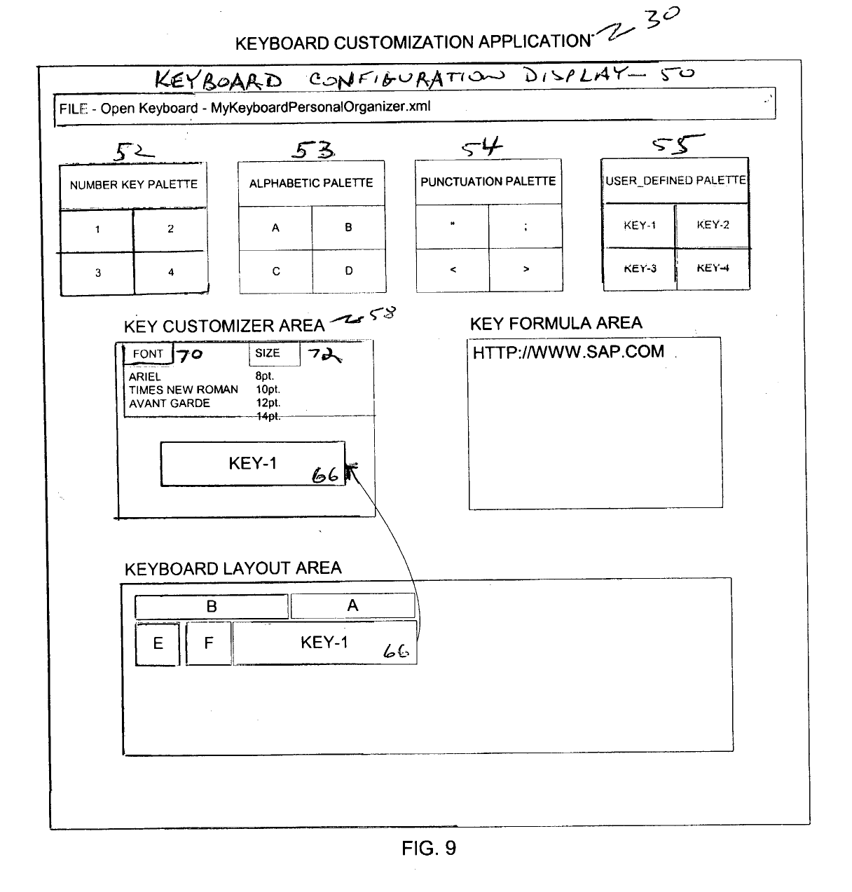

In one embodiment, selecting an available keyboard from available keyboard dialog box 88 and selecting open button 94 displays keyboard configuration display 50 with keys previously configured displayed in keyboard layout area 62 (FIG. 9). One or more keys from number key palette 52, alphabetic key palette 53, punctuation key palette 54, and user-defined key palette 55 may be configured in key customization area 58. In addition, any key located in keyboard layout area 62 may be reconfigured in key customization area 58 and rearranged among other keys in keyboard layout area 62. For example, KEY-1 66 may be moved from key layout area 62 to key customization area 58 for further customization.

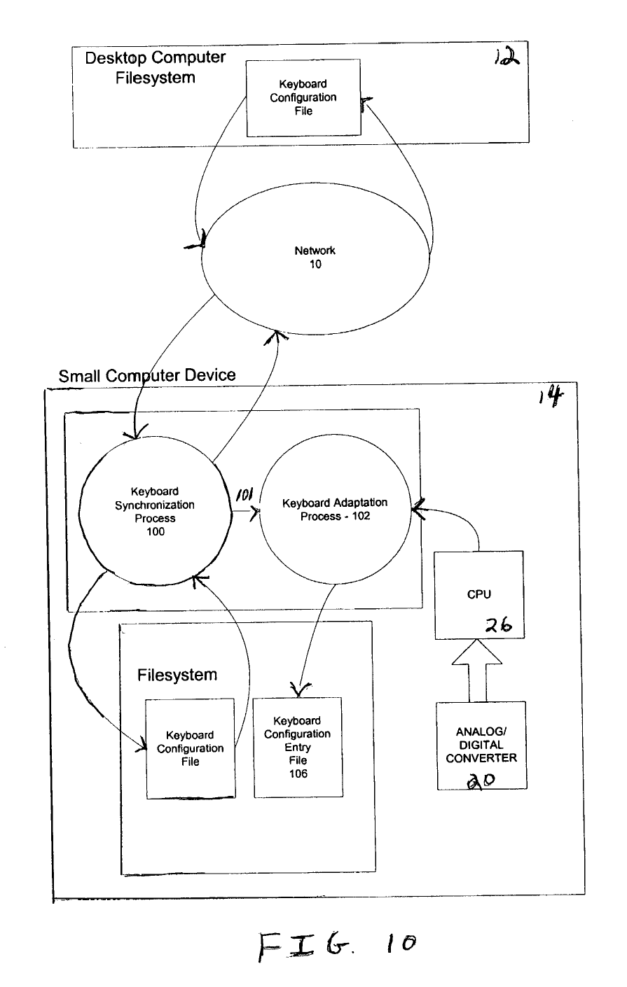

As shown in FIG. 10, a keyboard synchronization process 100 is provided to synchronize configuration files on desktop computer 12 and small computer device 14 using computer network 10. In addition, data synchronization process 100 may register available keyboard configuration files with a keyboard adaptation process 102 for keyboard use on small computer device 14. In one embodiment, for example, registering keyboard configuration files includes signaling 101 the keyboard adaptation process to enter an entry in an available keyboard configuration entry file 106 and installing an image icon representing the keyboard in a pulldown menu accessible on small computer device 14.

The keyboard adaptation process 102 is a software program that may be executed on desktop computer 12 and small computer device 14. The keyboard adaptation process 102 may be executed on any system that may use the software keyboard. In one embodiment, keyboard adaptation process 102 may be executed at system start-up time and remain active while awaiting requests from users and application programs. In other embodiments, keyboard adaptation process 102 may be executed in response to a request by an application or user and terminated once the request is completed.

In one embodiment, for example, keyboard adaptation process 102 may process two types of requests. A first type of request may be to display a configured keyboard whose property file may have been generated using keyboard customization application 30. A second type of request may be to generate a software keyboard dynamically for use with a particular application. Other embodiments may process more than two types of requests.

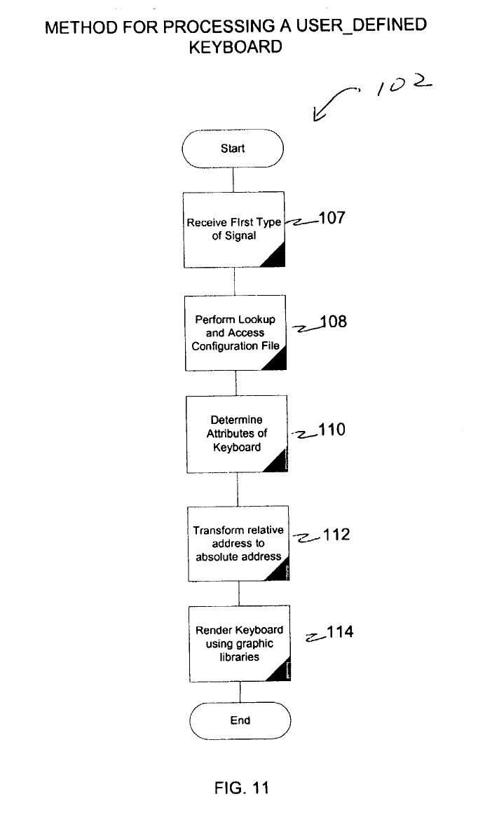

Referring to FIG. 11, a method of processing a first type of request is illustrated. Key adaptation process 102 may receive a first types signal 107 to display a particular keyboard on touch screen 16 in response to a users selection of the image icon registered by keyboard synchronization process 100. In one embodiment, upon receiving the first type of signal 107, key adaptation process 102 may perform a look-up in keyboard configuration entry file 106 and access the requested keyboard configuration file 108. Next, key adaptation process 102 may determine 110 the attributes (e.g., key shape, key size and key font) of each key to be displayed, transform 112 each keyboard keys relative display address attribute to an absolute display address coordinate for the particular small computer device touch screen 16, and render 114 the software keyboard image on touch screen 16 using graphic libraries that may be installed on small computer device 14. Once rendered, the software keyboard may be used as the default input device for data entry on small computer device 14.

With respect to the second type of request, a keyboard application programming interface is provided to application programs to generate a software keyboard dynamically. The API provides a precise definition of keyboard service requests available to applications to render a particular software keyboard. There may be several advantages that flow from this approach. One advantage may be that the development time of generating a particular keyboard may be reduced because an application programmer does not need to know how the keyboard adaptation process 102 will be implemented. Another benefit may be that more than one embodiment of the keyboard adaptation process 102 is possible without requiring changes to application programs.

The API functions through object definitions that may define the services provided to applications. In one embodiment, for example, the API may be implemented using the Java programming language. The disclosure, however, is not limited to the use of the Java programming.

The API may provide one or more service requests. The service requests may include initializing the keyboard adaptation process, generating a numeric keyboard, generating an alpha keyboard, retrieving select focus, determining input fields and rendering keyboards for display.

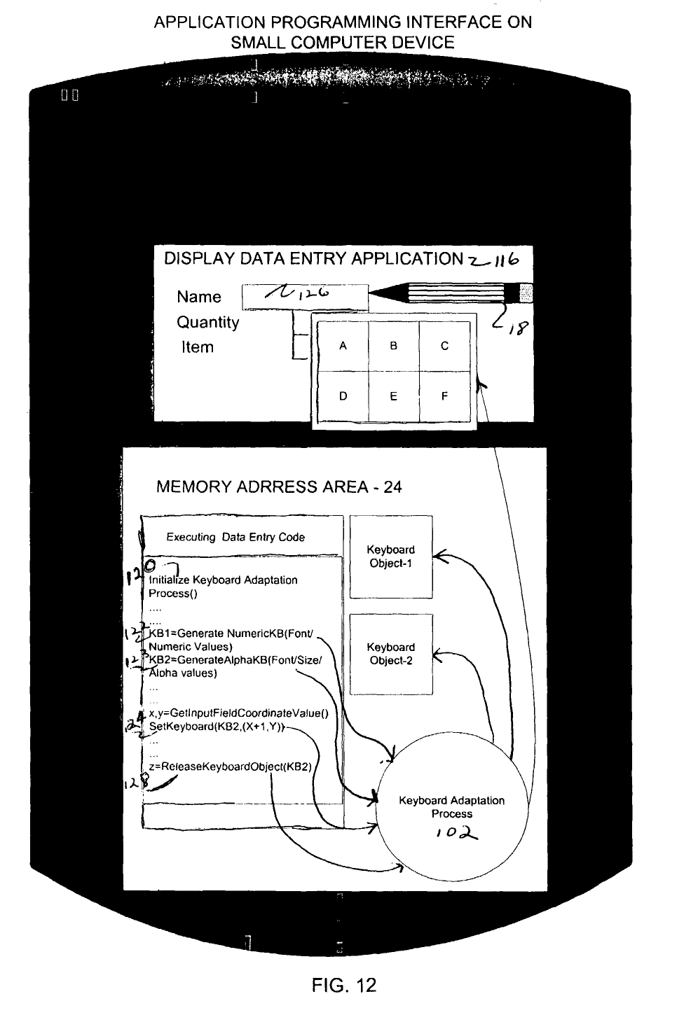

Referring to FIG. 12, for example, data entry application 116 and keyboard adaptation process 102 may be executed in memory address area 24 of small computer device 14. An initialize keyboard adaptation process 120 may establish a connection to the keyboard adaptation process 102 and register a data entry application 116 as a program that may request services. In some embodiments, initialize keyboard adaptation service 120 may identify whether keyboard adaptation process 102 is executing and, if not, instantiate an instance of keyboard adaptation process 102 in memory address area 24. One or more connections may be established with keyboard adaptation process 102 depending on the number of services requested by data entry application 116. For example, in one embodiment, an application that may display three varied software keyboards for varied contexts of use may establish three separate connections to key adaptation process 102. Other embodiments may establish connections with keyboard adaptation process 102 on an as-needed basis. Connections to keyboard adaptation process 102 may be made by establishing a shared memory location where configuration and result information may be shared between data entry application 116 and keyboard adaptation process 102. Some embodiments may utilize one or more interprocess communication techniques between data entry application 116 and keyboard adaptation process 102.

Once an application connection is established to the keyboard adaptation process 102, the data entry application 116 may request one or more keyboard generation and display services. As illustrated in FIG. 12, a generate numeric keyboard service request 122 may have one or more keyboard key configuration parameters associated with it. In one embodiment, for example, the parameters may include the number of keys in the software keyboard, unique key identifiers, and name-value pair attributes that may be associated with each key in the software keyboard (e.g., key shape, key font, and key font size). Similarly, various service requests for alphabetic keyboards 123, punctuation keyboards, and combinations of alphabetic, punctuation, and numeric keyboards with associated keyboard key configuration parameters may be provided by the system. The keyboard adaptation service 102 may generate a keyboard object in memory address area 24 of small computer device 14 and return a memory address pointer representing an instance of the dynamically created keyboard through the API to data entry application 116.

A set keyboard display service request 124 may be provided by the API to render software keyboards on touch screen 16. As illustrated in FIG. 12, parameters associated with service request 124 may include the memory address pointer to the keyboard object generated by the keyboard adaptation process 102 and physical coordinate values for display of the software keyboard on touch screen 16. In one embodiment, a user who selects the name input field 126 with the stylus 18 in data entry application 116 may invoke analog/digital converter 20 to convert the analog coordinate value selected on touch screen 16 to a digital coordinate value that may be passed to data entry application 116. Data entry application 116 then may calculate an offset from the digital coordinate value and execute the set keyboard display service request 124 using the memory address pointer to the keyboard object in memory address area 24 and the calculated offset as input configuration parameters. Once executed, keyboard adaptation process 102 may display the keyboard object pointed to by the memory address pointer at the offset position calculated by data entry application 116 and return a status code indicating success or failure.

A release keyboard object service request 128 may be provided by the API to release memory associated with the keyboard object generated by keyboard adaptation process 102. In one embodiment, the release keyboard object request 128 may be sent to keyboard adaptation process 102 when a particular keyboard object is no longer needed by data entry application 116. In another embodiment, release keyboard object request 128 may be sent to keyboard adaptation process 102 upon termination of data entry application 116.

The release keyboard object service request 128 accepts a memory address pointer to the keyboard object as its parameter. Upon receiving request 128, keyboard adaptation process 102 may unreserve the block of memory pointed to by the memory address pointer and may send it back to a free memory pool. Furthermore, keyboard adaptation process 102 may set the memory address pointer to the keyboard object in an uninitialized state that may be reinitialized before use again.

Various features of the system discussed above may be implemented using circuitry, such as a processor, or other hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

Other implementations are within the scope of the claims.

What is claimed is:

1. An article comprising a machine-readable medium storing machine-readable instructions that, when applied to the machine, cause the machine to:
provide a keyboard customization application to configure a user-customized configuration file; and
generate a user-customized software keyboard on a display in response to a request using the user-customized configuration file as input.

2. The article of claim 1 including instructions that, when applied to the machine, cause the machine to provide one or more key palettes from the keyboard customization application comprising one or more keys for selection in the user-customized software keyboard.

3. The article of claim 1 including instructions that, when applied to the machine, cause the machine to provide a key customization area from the keyboard customization application for modifying at least one individual key font type, key font size, and key font shape for selection in the user-customized software keyboard.

4. The article of claim 1 including instructions that, when applied to the machine, cause the machine to provide a key formula area from the keyboard customization application for specifying one or more instructions to be associated with a user-defined key.

5. The article of claim 1 including instructions that, when applied to the machine, cause the machine to provide a keyboard layout area from the keyboard customization application for arranging a position of one or more individual keys in the user-customized keyboard.

6. The article of claim 1 including instructions that, when applied to the machine, cause the machine to:
determine a target computer device name using a user-entered device name as input;
calculate a total number of keyboard keys using one or more keys in a keyboard layout area as input;
calculate a keyboard size using a physical coordinate position value of one or more keys in the keyboard layout area as input;
calculate a relative key coordinate value for one or more keys in the keyboard layout area using as input the physical coordinate position value associated with one or more keys and the keyboard size;
access at least one of a key font attribute, a key size attribute and a key shape attribute associated with one or more keys in the keyboard layout area; and
store the target computer device name, the total number of keyboard keys, the keyboard size, the relative key coordinate for one or more keys, and at least one of the key font type for one or more keys, the key font size for one or more keys, and the key font shape for one or more keys in the user-customized configuration file.

7. The article of claim 6 including instructions that, when applied to the machine, cause the machine to:
access the user-customized configuration file using as input the request and a directory location of the user-customized configuration file in response to receiving a request to display a user-customized software keyboard;
calculate a physical address on the display for one or more keys using as input one or more relative key coordinates, a target computer device name and a total number of keyboard keys; and
render the software keyboard on the display using as input the physical address for one or more keys., a key font type for one or more keys, a key font size for one or more keys, and a key font shape for one or more keys.

8. An article comprising a machine-readable medium storing machine-readable instructions that, when applied to the machine, cause the machine to:
provide an application programming interface to configure an application-customized software keyboard on a display; and
generate an application-customized software keyboard in response to a request using as input an application programming interface.

9. The article of claim 8 including instructions that, when applied to the machine, cause the machine to provide one or more functions from the application programming interface to establish a connection with a keyboard adaptation process.

10. The article of claim 8 including instructions that, when applied to the machine, cause the machine to provide one or more functions from the application programming interface to generate the application-customized software keyboard in a computer memory.

11. The article of claim 8 including instructions that, when applied to the machine, cause the machine to:
generate a keyboard object using as input an instruction from a requester and a set of keyboard parameters;
store the keyboard object in a computer memory; and
send a memory location of the keyboard object in the computer memory to the requester.

12. The article of claim 8 including instructions that, when applied to the machine, cause the machine to render the application-customized software keyboard on the display in response to a request for a keyboard service using as input one or more functions from the application programming interface.

13. The article of claim 12 including instructions that, when applied to the machine, cause the machine to render the application-customized software keyboard on the display using the keyboard service in response to a request from the application programming interface comprising a memory address pointer, a keyboard display coordinate value, and a computer graphic library.

14. A system comprising:
a computer network;
a directory coupled to the network, the directory storing a user-customized configuration file and an application programming interface;
a display device;
a service delivery device coupled to the network, the service delivery device including a processor and memory storing instructions that, in response to receiving a first type of request for access to a service, cause the processor to:
provide a keyboard customization application to configure a user-customized configuration file; and
generate a user-customized software keyboard on the display in response to a request using the user-customized configuration file as input;
wherein the memory further stores instructions that, in response to a second type of request for access to a service, cause the processor to:
generate an application-customized software keyboard on the display device using the application programming interface as input.

15. The system of claim 14 wherein the memory stores instructions that, in response to receiving the first type of request, cause the processor to provide one or more key palettes from the keyboard customization application comprising one or more keys for selection in the user-customized software keyboard.

16. The system of claim 14 wherein the memory stores instructions that, in response to receiving the first type of request, cause the processor to provide a key customization area from the keyboard customization application for modifying individual key font type, key font size, and key font shape for selection in the user-customized software keyboard.

17. The system of claim 14 wherein the memory stores instructions that, in response to receiving the first type of request, cause the processor to provide a key formula area from the keyboard customization application for specifying one or more instructions to be associated with a user-defined key.

18. The system of claim 14 wherein the memory stores instructions that, in response to receiving the first type of request, cause the processor to provide a keyboard layout area from the keyboard customization application for arranging a position of one or more individual keys in the user-customized keyboard.

19. The system of claim 14 wherein the memory stores instructions that, in response to receiving the first type of request, cause the processor to:
determine a target computer device name using as input a user-entered device name;
calculate a total number of keyboard keys using as input one or more keys in a keyboard layout area;
calculate a keyboard size using as input a physical coordinate position value of one or more keys in the keyboard layout area;
calculate a relative key coordinate value for one or more keys in the keyboard layout area using as input the physical coordinate position value associated with one or more keys and the keyboard size;
access a key font attribute, a key size attribute and a key shape attribute associated with one or more keys in the keyboard layout area; and
store the target computer device name, the total number of keyboard keys, the keyboard size, the relative key coordinate for one or more keys, the key font type for one or more keys, the key font size for one or more keys, and the key font shape for one or more keys in the user-customized configuration file.

20. The system of claim 19 wherein the memory stores instructions that, in response to receiving the first type of request, cause the processor to:
access the user-customized configuration file using as input the first type of request and a directory location of the user-customized configuration file in response to receiving a request to display a user-customized software keyboard;
calculate a physical address on the display for one or more keys using as input one or more relative key coordinates, a target computer device name and a total number of keyboard keys;
render the software keyboard on the display using as input the physical address for one or more keys, a key font type for one or more keys, a key font size for one or more keys, and a key font shape for one or more keys.

21. The system of claim 14 wherein the memory stores instructions that, in response to receiving the second type of request, cause the processor to provide one or more functions from the application programming interface to establish a connection with a keyboard adaptation process.

22. The system of claim 14 wherein the memory stores instructions that, in response to receiving the second type of request, cause the processor to provide one or more functions from the application programming interface to generate the application-customized software keyboard in a computer memory.

23. The system of claim 14 wherein the memory stores instructions that, in response to receiving the second type of request, cause the processor to:
generate a keyboard object using as input an instruction from a requester and a set of keyboard parameters;
store the keyboard object in a computer memory; and
send a memory location of the keyboard object in the computer memory to the requester.

24. The system of claim 14 wherein the memory stores instructions that, in response to receiving the second type of request, cause the processor to render the application-customized software keyboard on the display in response to a request for a keyboard service using as input one or more functions from the application programming interface.

25. The system of claim 14 wherein the memory stores instructions that, in response to receiving the second type of request, cause the processor to render the application-customized software keyboard on the display using a keyboard service in response to a request from the application programming interface comprising a memory address pointer, a keyboard display coordinate value, and a computer graphic library.

26. A system comprising:
a directory storing a user-customized configuration file and an application programming interface;
a server coupled to the directory, the server adapted to:
provide a keyboard customization application to configure a user-customized configuration file;
generate a user-customized software keyboard on a display in response to a request using as input the user-customized configuration file;
provide an application programming interface to configure an application-customized software keyboard on a display; and
generate the application-customized software keyboard in response to a request using as input the application programming interface.

27. The system of claim 26 wherein the server is adapted to provide one or more functions from the application programming interface to establish a connection with a keyboard adaptation process.

28. The system of clain 26 wherein the server is adapted to:
generate a keyboard object using as input an instruction from a requester and a set of keyboard parameters;
store the keyboard object in a computer memory; and
send a memory location of the keyboard object in the computer memory to the requester.

29. The system of claim 26 wherein the server is adapted to render the application-customized software keyboard on the display in response to a request for a keyboard service using as input one or more functions from the application programming interface.

30. The system of claim 26 wherein the server is adapted to render the application-customized software keyboard on the display using a keyboard service in response to a request from the application programming interface comprising a memory address pointer, a keyboard display coordinate value, and a computer graphic library.

31. A method comprising:
providing a keyboard customization application to configure a user-customized configuration file; and
generating a user-customized software keyboard on a display in response to a request using the user-customized configuration file as input.

32. The method of claim 31 including providing the keyboard customization application provides with one or more key palettes comprising one or more keys for selection in the user-customized software keyboard.

33. The method of claim 31 including providing the keyboard customization application with a key customization area for modifying at least one of individual key font type, key font size, and key font shape for selection in the user-customized software keyboard.

34. The method of claim 31 including providing the keyboard customization application with a key formula area for specifying one or more instructions to be associated with a user-defined key.

35. The method of claim 31 including providing the keyboard customization application with a keyboard layout area for arranging a position of one or more individual keys in the user-customized keyboard.

36. The method of claim 31 wherein generating a user-customized configuration file comprises:
determining a target computer device name using as input a user-entered device name;
calculating a total number of keyboard keys using as input one or more keys in a keyboard layout area;
calculating a keyboard size using as input a physical coordinate position value of one or more keys in the keyboard layout area;
calculating a relative key coordinate value for one or more keys in the keyboard layout area using as input the physical coordinate position value associated with one or more keys and the keyboard size;
accessing at least one of a key font attribute, a key size attribute and a key shape attribute associated with one or more keys in the keyboard layout area; and
storing the target computer device name, the total number of keyboard keys, the keyboard size, the relative key coordinate for one or more keys, at least one of the key font type for one or more keys, the key font size for one or more keys, and the key font shape for one or more keys in the user-customized configuration file.

37. The method of claim 36 wherein generating the user-customized software keyboard comprises:
receiving a request to display a user-customized software keyboard;
accessing the user-customized configuration file using as input the request and a directory location of the user-customized configuration file;
calculating a physical address on the display for one or more keys using as input one or more relative key coordinates, a target computer device name and a total number of keyboard keys; and
rendering the software keyboard on the display using as input the physical address for one or more keys, the key font type for one or more keys, the key font size for one or more keys, and the key font shape for one or more keys.

38. A method comprising:
providing an application programming interface to configure an application-customized software keyboard on a display; and
generating an application-customized software keyboard in response to a request using as input an application programming interface.

39. The method of claim 38 including providing the application programming interface with one or more functions to establish a connection with a keyboard adaptation process.

40. The method of claim 38 including providing the application programming interface with one or more functions to request a keyboard adaptation process to generate the application-customized software keyboard in a computer memory.

41. The method of claim 40 wherein the keyboard adaptation process comprises:
receiving an instruction from a requester to generate a keyboard object and a set of keyboard parameters;
generating the keyboard object using as input the set of instructions;
storing the keyboard object in a computer memory; and
sending a memory location of the keyboard object in the computer memory to the requester.

42. The method of claim 38 including providing the application programming interface with one or more functions to request a keyboard service to render the application-customized software keyboard on the display.

43. The method of claim 42 wherein the keyboard service process comprises:
receiving an instruction from a requester to display the application-customized software keyboard and a set of keyboard parameters comprising a memory address pointer and keyboard display coordinate values; and
displaying the application-customized software keyboard using as input the memory address pointer, the keyboard display coordinate values, and a computer graphics library.
